(19) United States
(12) Patent Application Publication
(10) Pub. No.: US 2022/0236492 A1
(43) Pub. Date: Jul. 28, 2022

(54) MULTICORE OPTICAL FIBER COUPLER/DEVICE/ADAPTER APPARATUS, METHODS, AND APPLICATIONS

(71) Applicant: UNIVERSITY OF CENTRAL FLORIDA RESEARCH FOUNDATION, INC., Orlando, FL (US)

(72) Inventors: Rodrigo Amezcua Correa, Orlando, FL (US); Juan Carlos Alvarado Zacarias, Orlando, FL (US); Jose Enrique Antonio Lopez, Orlando, FL (US)

(73) Assignee: UNIVERSITY OF CENTRAL FLORIDA RESEARCH FOUNDATION, INC., Orlando, FL (US)

(21) Appl. No.: 17/648,473

(22) Filed: Jan. 20, 2022

Related U.S. Application Data
(60) Provisional application No. 63/140,380, filed on Jan. 22, 2021.

(51) Int. Cl. G02B 6/38; G02B 6/02

(52) U.S. Cl. CPC G02B 6/3825; G02B 6/3867; G02B 6/02042

(57) ABSTRACT

A multicore fiber-to-single core fiber adapting device, also referred a fan-in/fan-out (FIFO) device. More specifically, an optical fiber system comprising a multicore fiber, a tapered glass device that it is configured to connect a multicore fiber to a multiple single core fiber, and/or single mode fibers, advantageously having one or more protective layers to protect the tapered device. Associated methods of manufacture.

### RELATED APPLICATION DATA

The instant application claims priority from U.S. provisional application 63/140,380 filed Jan. 22, 2021, the subject matter of which is incorporated by reference in its entirety.

### GOVERNMENT FUNDING

Funding for the invention was provided by ARO under contract W911NF1210450. The U.S. government has certain rights in the invention.

### BACKGROUND

Non-limiting aspects and embodiments most generally pertain to the field of optical fiber coupler/adaptor apparatus, related production methods, and applications thereof; more particularly to an optical fiber system configured to couple a multicore fiber to multiple single-core and/or single-mode fibers; and, most particularly to a multicore fiber to single-core fiber coupler/adapter (referred to herein after as a fan-in/fan-out (“FIFO”) device), related production methods, and applications thereof.

Fiber optic communication networks include a number of interconnection points at which multiple fibers converge. The data capacity of a network is increased by adding more fibers to the optical links, i.e., installing additional optical fiber cables and/or cables with higher numbers of single core fibers. Since space is limited, the addition of fibers is challenging. Multicore fibers are seen as an alternative to increase the number of cores and therefore the transmission capacity in a network.

Optical fiber transmission over single-mode fibers (SMF) is approaching its theoretical capacity limitations. Newer technologies such as multicore fibers (MCF) offer promising solutions to overcome the data transmission capacity limit of single mode fibers and/or increase the number of optical cores within limited space and/or increase the number of optical cores within congested duct systems and/or improve the energy efficiency of fiber communications systems. A critical component of multicore fiber transmission systems is the interface between single-core and multicore fibers, given the fact that high coupling efficiency is required to lower the transmission penalties. Devices that can provide high coupling efficiency and low channel crosstalk are advantageous for future multicore fiber deployment.

Different approaches to interface single-core and multicore fibers have been proposed, including connectors with reduced cladding fibers that are stacked into a ferrule that contains the fibers. A disadvantage of this is the difficulty of precisely positioning the fibers within the ferrule to match the position of the cores of the multicore fiber. Another approach is the use of a set of fibers inserted into a glass capillary tube that is then tapered until the fiber core separations within the tube match those of the multicore fiber. Previous tapered fiber bundle approaches result in high losses and/or channel crosstalk when coupling to the multicore fiber. Furthermore, tapered fiber bundle approaches have been proposed that use fibers with one or more refractive index layers in the cladding so as to better match the mode field diameter of the multicore fiber.

The main challenge remains to deliver a fan-in/fan-out device (optical coupler) for the interface between a set of single-core fibers and a multicore fiber. Especially important is to couple the multicore fiber to a plurality of single-core, single mode fibers. In view of the technological deficiencies and shortcomings in the current state of the art, the inventors have recognized the need for solutions that address at least the creation of low loss, low crosstalk transitions from multiple single-core fibers to a multicore fiber, the precise alignment of the single-core fibers and the cores of the multicore fiber, and significantly reducing insertion loss and crosstalk between the multiple channels. Providing high coupling efficiency and low channel crosstalk between single-core and multicore fibers is highly advantageous. Such low-loss, low crosstalk fan-in/fan-out devices that can be configured for a given multicore fiber will provide the telecommunications field the ability to exploit multicore fibers for data center interconnect networks, access and metro optical networks, and long-haul and submarine optical networks to name a few.

Aspects and embodiments of the present invention as set forth herein enable high efficiency, low channel crosstalk, single-core to multicore fiber fan-in/fan-out devices, manufacturing methods, and commercial applications.

### SUMMARY

An embodiment of the invention is a capillary template for a fan-in/fan-out device. In an exemplary, non-limiting aspect the capillary template includes an elongate, solid cylindrical body having a plurality of longitudinal access holes, wherein the solid cylindrical body has at least one region surrounding each access hole having a refractive index that is lower than the cladding refractive index of the single-core fibers used in fabricating the fan-in/fan-out (to enable total internal reflection after tapering). In various non-limiting, exemplary embodiments and aspects the capillary template may have one or more of the following features, characteristics, limitations, or functions alone or in various combinations:
wherein the plurality of longitudinal access holes are through-holes;
wherein all of the surrounding region has a uniform index distribution;
wherein the at least one region surrounding each access hole is Fluorine-doped silica;
further comprising a single-core fiber disposed in each access hole;
   further comprising a different fiber spliced to an end of each single-core fiber and disposed within the respective longitudinal access holes;
      wherein each different fiber is a graded index fiber or any other single core fiber;
   wherein the plurality of single-core fibers extend out of the respective access holes.

An embodiment of the invention is a fan-in/fan-out device. In an exemplary, non-limiting aspect the fan-in/fan-out device includes an elongate, tapered capillary body having a single-core fiber end and a multicore fiber end (along the tapered section, the diameter of the capillary body is reduced from the single-core fiber end towards the multicore fiber end), a plurality of single-core fibers disposed in the capillary body, a respective plurality of light-propagating regions extending from the single-core fiber end to the multicore fiber end of the capillary body, wherein the single-core fibers have a cladding having a lower index of refraction than the light-propagating regions and the capillary body has one or more transverse regions having index values that are less than the single-core fiber cladding indices, further wherein as the capillary body tapers from the single-core fiber end towards the multicore-fiber end, the light confinement function of the lower index fiber cladding being increasingly provided by the lower index region(s) of the capillary surrounding region(s). In various non-limiting, exemplary embodiments and aspects the fan-in/fan-out device may have one or more of the following features, characteristics, limitations, or functions alone or in various combinations:
wherein at least one of the plurality of single-core and/or the multicore fiber end include a connector(s);
wherein the fan-in/fan-out devices are connected to each end of a multicore fiber.

An embodiment of the invention is a method for making a capillary template for a fan-in/fan-out device. In an exemplary, non-limiting aspect the method includes the steps of providing at least a first hollow tube having outside diameter, D₁, and index, n₁, and at least a first solid rod having an outside diameter, D_{R}, and index, n_{R}, advantageously n_{R} is equal to n₁, drawing the at least first hollow tube and the at least first solid rod into lengths having smaller diameters than D₁, while not completely collapsing the inner air space of the hollow tube(s), assembling a plurality of the drawn tubes and the drawn rods in a desired configuration (advantageously within a housing tube), to create a preform stack, and drawing down the preform stack to create a capillary template having ≥2 precisely aligned/positioned air channels, wherein the air channels' diameters are sized to allow the insertion of single-core fibers (having e.g., cladding diameters preferably of 125 μm), wherein at least one region surrounding the air channels has a refractive index less than the cladding refractive index of the inserted single-core fibers. In various non-limiting, exemplary embodiments and aspects the method may have one or more of the following steps, features, characteristics, limitations, or functions alone or in various combinations:
wherein the at least first hollow tube has a plurality of concentric regions of different refractive indices, n₁, n₂, . . . nᵢₙₙₑᵣₘₒₛₜ, where nᵢₙₙₑᵣₘₒₛₜ is the region surrounding the air channels;
further comprising providing at least a second hollow tube having outside diameter, D₂, and index, n₂, where advantageously n_{R} is smaller or equal to n₂; and drawing down the at least first and second hollow tubes and the at least first solid rod such that the first tube can be concentrically disposed in the second tube, and assembling and drawing down the stacked preform.

An embodiment of the invention is a method for making a fan-in/fan-out device. In an exemplary, non-limiting aspect the method includes the steps of providing a capillary template as in, inserting a single-core fiber into each respective access hole, elongating and tapering down the capillary template including the fibers disposed therein, whereby the single-core end and the multicore fiber end can be connected to a respective single-core fiber end and a multicore fiber end of a transmission system.

### BRIEF DESCRIPTION OF THE DRAWING FIGURES

FIGS. 1-4 are cross sectional end views illustrating the four-stage process of making a capillary template, according to non-limiting, exemplary embodiments.

FIGS. 5-7 are cross sectional end views illustrating the transverse refractive index profiles of the capillary template, according to non-limiting, exemplary embodiments.

FIGS. 8, 21 show cross sectional end views illustrating, non-limiting exemplary transverse refractive index profiles of single core input fibers used in various embodiments of the device.

FIGS. 9, 10, 22 are cross sectional end views illustrating the transverse refractive index profiles of embodiments of the fabricated fan-in/fan-out device at the multicore fiber end thereof.

FIG. 11 (left) is a cross sectional end view of a stacked capillary template preform (Stage 3 of FIGS. 1-4) having multiple-sized solid rods to form an interior of the fabricated (right).

FIG. 12 is a cross sectional end view of a capillary template having drilled access holes for the single-core fiber, according to a non-limiting, exemplary embodiment.

FIG. 13 shows sequential (left to right) cross sectional end views representative of the process for making a drilled-hole capillary template, according to a non-limiting, exemplary embodiment.

FIGS. 14, 19, 20 are schematic perspective illustrations of a glass capillary template, according to a non-limiting, exemplary embodiment.

FIG. 15 shows schematic cross sectional views of fan-in/fan-out devices having connectors at either or both ends of the fan-in/fan-out devices.

FIGS. 16, 23, 24, 25 are schematic cross sectional views of fan-in/fan-out devices according to various embodiments. In FIG. 16, on the left-hand side, single-core fibers are disposed into the access holes of the capillary template and taper down, where d₁ represents the initial single-core fiber core to core distance before taper and d₂ corresponds to the light propagating core to core distance at the tapered multicore fiber end of the fan-in/fan-out. At the multicore fiber end of the fan-in/fan-out, the light confinement in the cores provided by the lower index claddings is now provided by the lower index material of the device (e.g., F-doped silica) surrounding the light propagating regions.

FIGS. 17, 18, and 27 are schematic views of an embodied fan-in/fan-out device. After inserting single-core fibers into the fabricated capillary template access holes, the complete assembly is drawn (elongated) and adiabatically tapered down to create a multicore fiber end.

### DETAILED DESCRIPTION OF NON-LIMITING, EXEMPLARY EMBODIMENTS

Disclosed embodiments are described with reference to the attached figures, wherein like reference numerals are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships and methods are set forth to provide a more complete understanding of the embodiments disclosed herein.

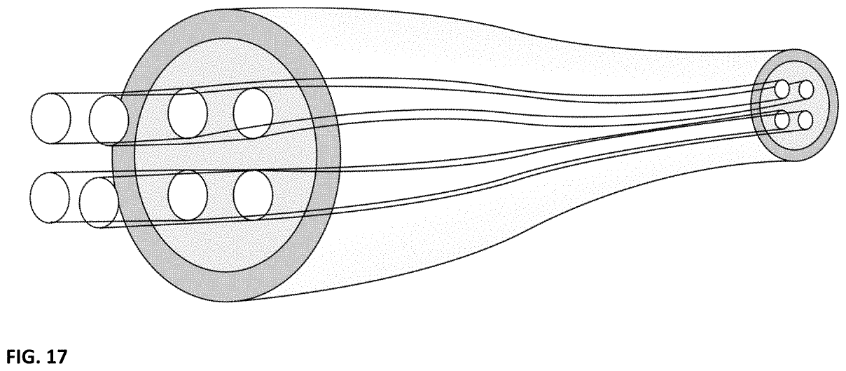

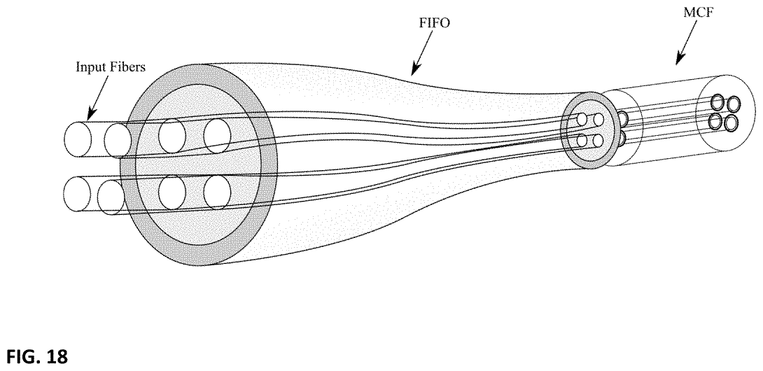

In its most general aspect, FIG. 17 shows, in longitudinal cross section, an optical fiber fan-in/fan-out device having a multiple single-core fiber (M-SCF) end (left) and a multicore fiber end (right). A plurality (four as illustrated) of single core fibers is disposed in the body portion and extend from the M-SCF end of the device. The multicore fiber end of the device has a respective plurality of pre-aligned, light-transmitting core regions, for splicing the multicore fiber end of the fan-in/fan-out to a multicore fiber (FIG. 18, 27).

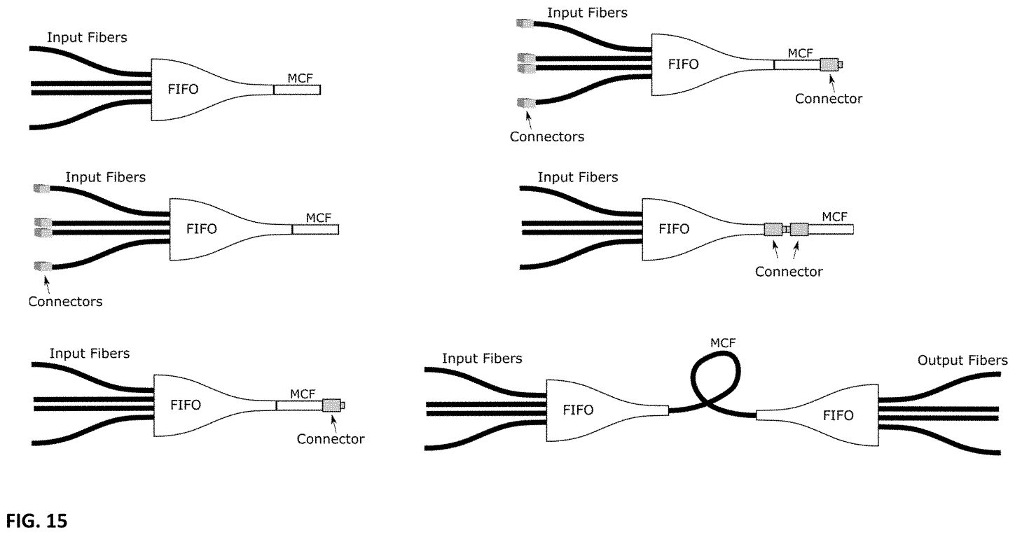

In an exemplary, non-limiting embodiment, the multiple single mode fibers have connectors, examples of which include but are not limited to SC, LC, CS, MTP, and ST, as known in the art, as illustrated in FIG. 15.

In an exemplary, non-limiting embodiment, the multicore fiber end of the fan-in/fan-out device includes a connector that may include but is not limited to one of a SC, LC, CS, MTP, and ST type connector as known in the art (FIG. 15).

An exemplary, non-limiting embodiment of the fan-in/fan-out device may include any combination of, or all of the foregoing embodied features, thus providing an end user a fan-in/fan-out device ready for convenient, plug-n-play connection to the multiple single-core fibers at one end and a multicore fiber at the other end in their system (FIG. 15).

Further details about the embodied fan-in/fan-out device will emerge throughout and following the exemplary manufacturing methods for capillary templates and fan-in/fan-out as described herein below.

Hole Drilling Method

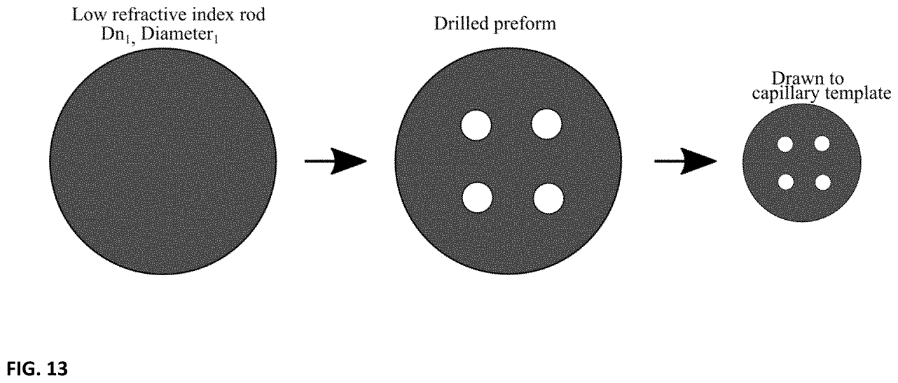

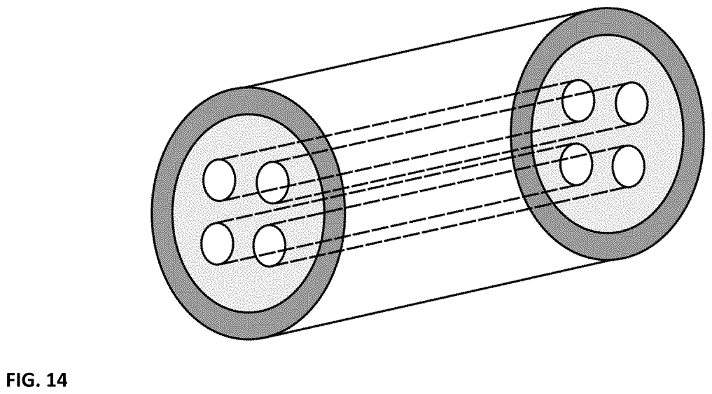

An exemplary, non-limiting method of making a capillary template for a fan-in/fan-out device is illustrated in FIG. 13. It involves providing a low refractive index rod of diameter, D₁, and index n_{R}, drilling a plurality of parallel, longitudinal access holes in the preform that may or may not be through-holes, and drawing down the preform to form the capillary template. The material may appropriately be glass (e.g., Fluorine-doped), have a relatively large cross sectional diameter, D₁, of 10 mm-60 mm (nominally 30 mm), and a refractive index that has a lower value than the cladding material of the single core fibers. The access holes (air-channels) are obtained by drilling into the length of the cylinder. As each access hole will ultimately be occupied by a respective single-core, the number of access holes (≥2) will be determined by the multicore fiber to which the fan-in/fan-out will ultimately be connected. Subsequently the drilled cylinder is drawn down to create a capillary template. Since single core fibers typically have a cladding diameter of about 125 μm, the diameter of the drilled holes, after final draw, will be appropriately larger to allow insertion of the single-core fibers. The single-core fiber cladding may typically be pure silica and the refractive index difference between the glass capillary template and the cladding of the single-core fibers is advantageously between −2×10⁻³ to −20×10⁻³. Appropriate glass capillary template materials will be known in the art. The glass capillary template may further be surrounded by one or more additional material layers. Alternatively, the capillary template may, e.g., be undoped silica glass and the single-core fibers may be doped with, e.g., Ge, to raise their cladding index. Ultimately, total internal reflection must be maintained to confine light to the fibers' cores.

In order to precisely position the light propagating core regions of the fan-in/fan-out, the diameter of the capillary template access holes is advantageously not more than 15% larger than the outer diameter of the inserted single-core fibers. More advantageously, the access holes' diameters will advantageously be 0.5-20 μm, and more advantageously 2-5 μm larger than the diameter of the single-core fibers that are used.

Stack and Draw Method

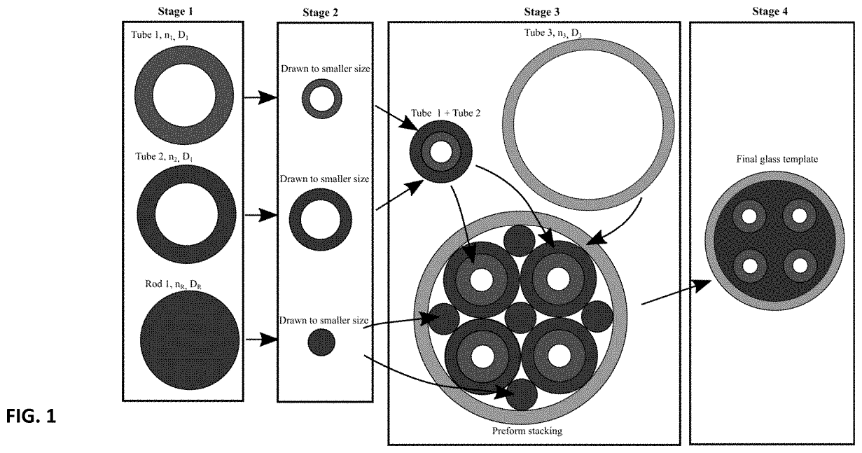

An advantageous fabrication method for an embodied capillary template incorporates a) providing one or more tubes and one or more rods of appropriate material sizes and materials, b) drawing down the tube(s) and rod(s), c) assembling the drawn tubes and rods as desired, and d) further drawing down the assembly, illustrated as respective Stages 1, 2, 3, 4 in FIGS. 1-4. This method advantageously enables a non-uniform transverse refractive index profile in the ultimate fan-in/fan-out device.

As illustrated, for example, in FIG. 1 at Stage 1, a first hollow tube having outside diameter, D₁, and index, n₁, a second hollow tube having outside diameter, D₂, and index, n₂, and a solid rod having outside diameter, D_{R}, and index, n_{R}, all of appropriate material are provided. At Stage 2, these tubes and rod are drawn down into lengths having smaller diameters as illustrated. As illustrated in Stage 3, tube 1 is drawn to a diameter to concentrically fit inside of tube 2 while maintaining the access hole of tube 1, forming tube 1/2 with concentric indices n₁, n₂, where n₁, will be less than the cladding index of the single-core fibers used in fabricating the fan-in/fan-out. The indices n₂ and n_{R} are not critical for waveguiding at the multicore fiber end of the fan-in/fan-out device as long as total internal reflection is provided by n₁; however, n₂ and n_{R} may be selected to reduce/minimize crosstalk and/or optimize other performance criteria of the ultimate fan-in/fan-out device. The four tube assemblies 1/2 and five solid rods (as shown for illustration purposes) are assembled in a housing tube 3 (e.g., undoped silica) to create a stacked preform. The preform is then again drawn down to create a glass capillary template having multiple (must be ≥2, four as shown for illustration purposes) precisely aligned/positioned single-core access holes, as shown in Stage 4. The access holes' diameters are sized to allow the insertion of single-core fibers (e.g., diameter 125 μm. However, single-core fibers with a different diameter than 125 μm can be used).

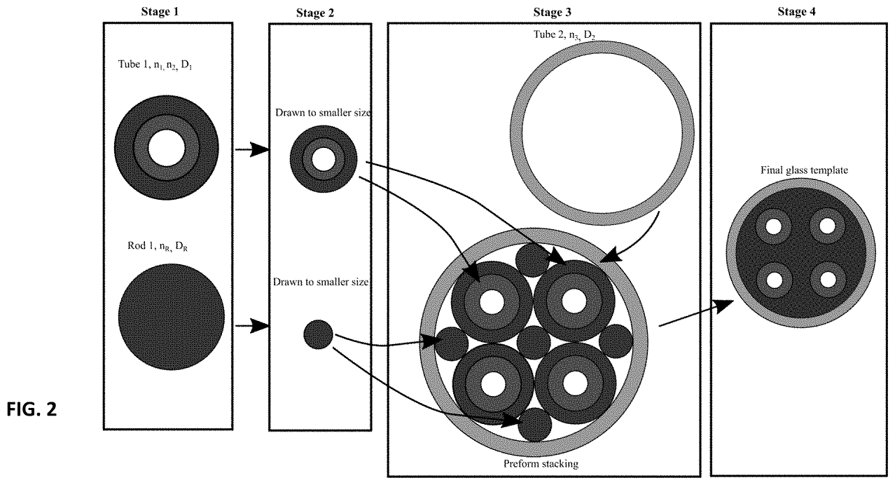

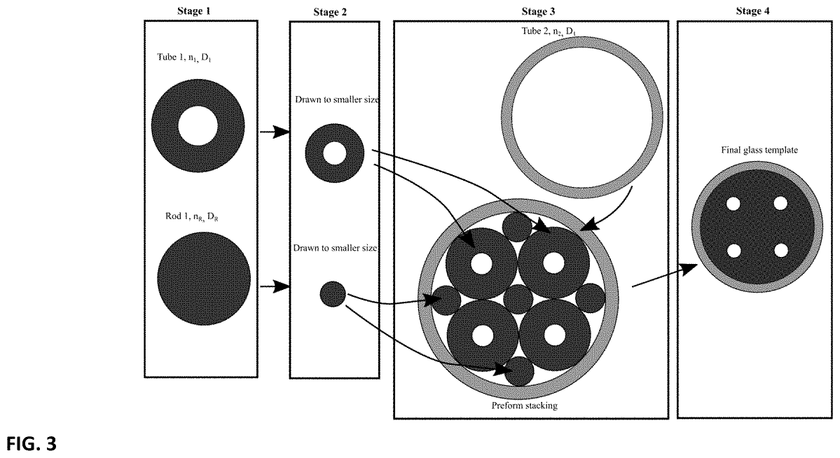

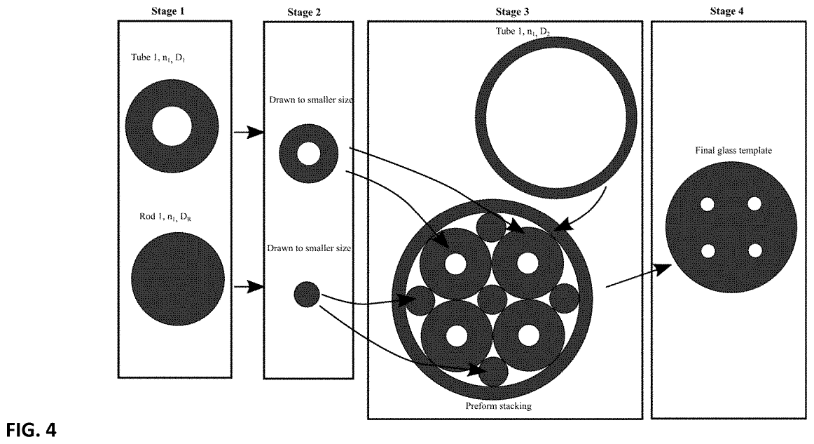

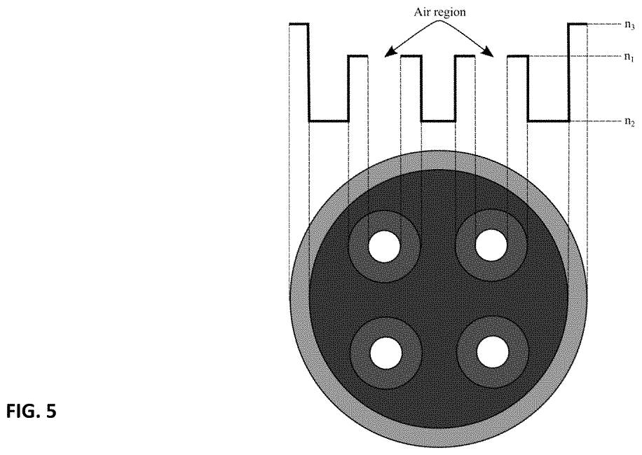

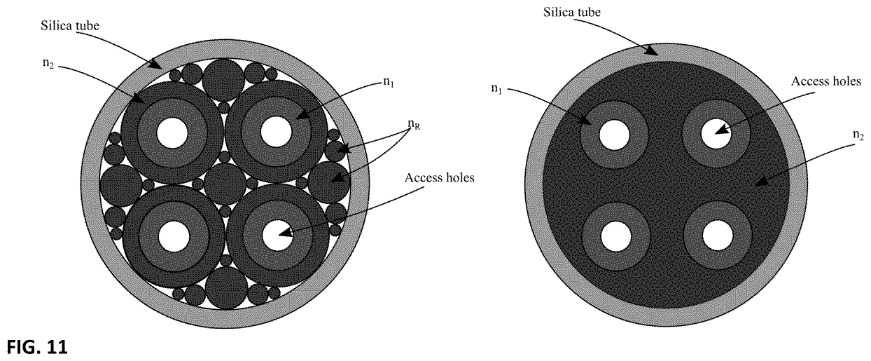

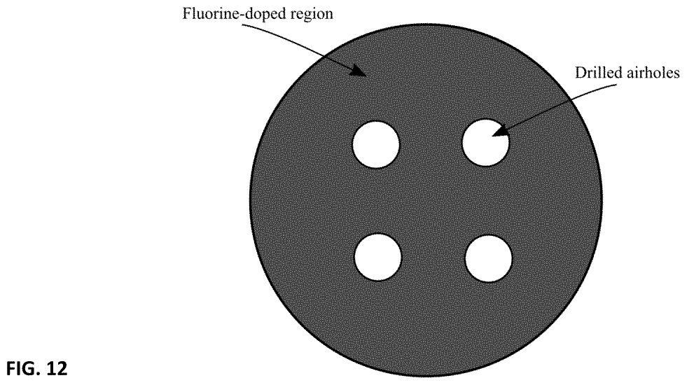

FIGS. 2-4 and 11 show non-limiting alternative stacked capillary template preform assemblies; e.g., a single tube having a non-uniform radial index profile (FIG. 2); a single tube having a uniform index equal to that of n_{R} and a housing tube 2 of different index (FIG. 3); and, a single tube having a uniform index equal to that of n_{R} and a housing tube 2 of equal index (FIG. 4).

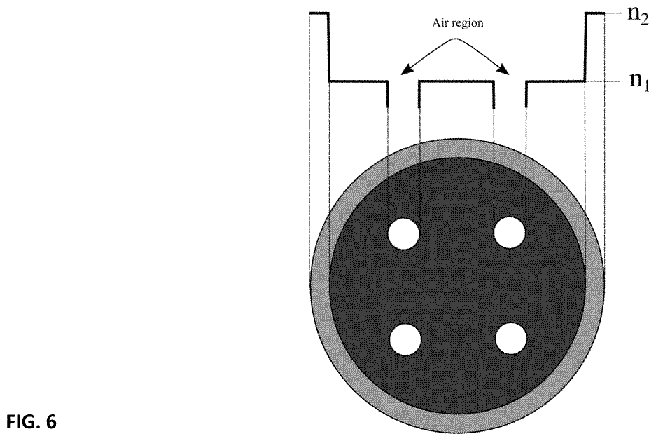

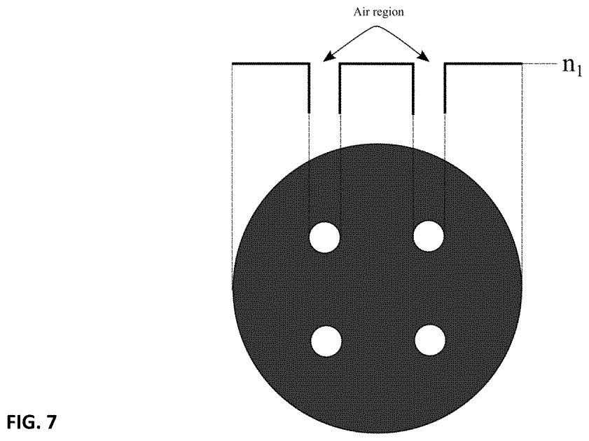

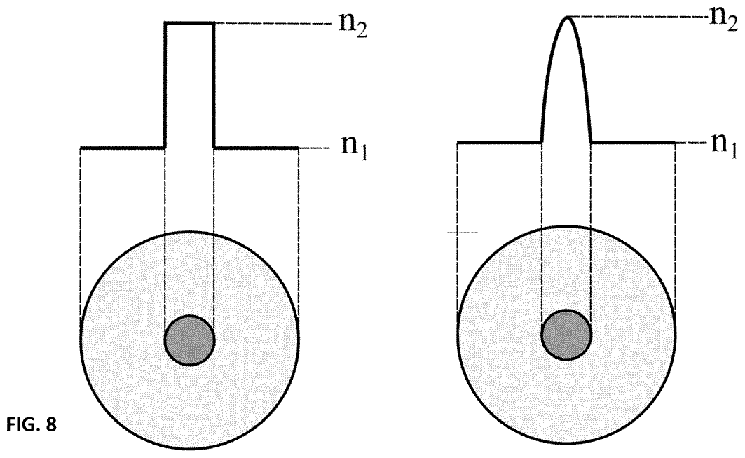

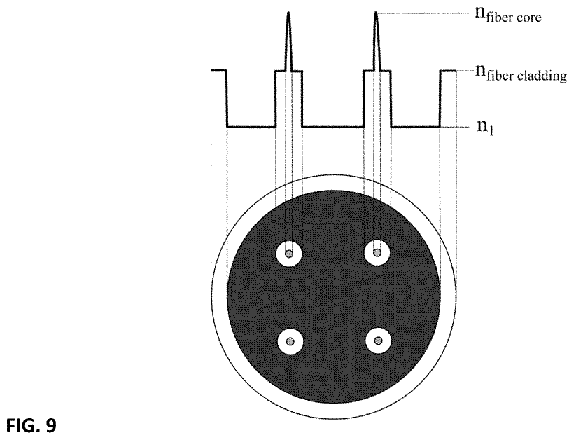

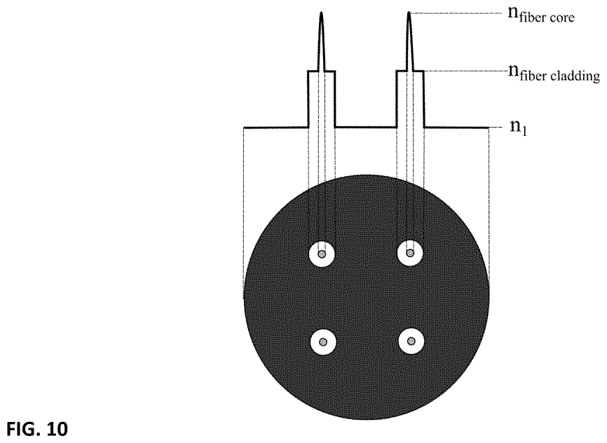

FIGS. 5-7 show resulting transverse index profiles of the capillary preform according to the various embodied stacking methods.

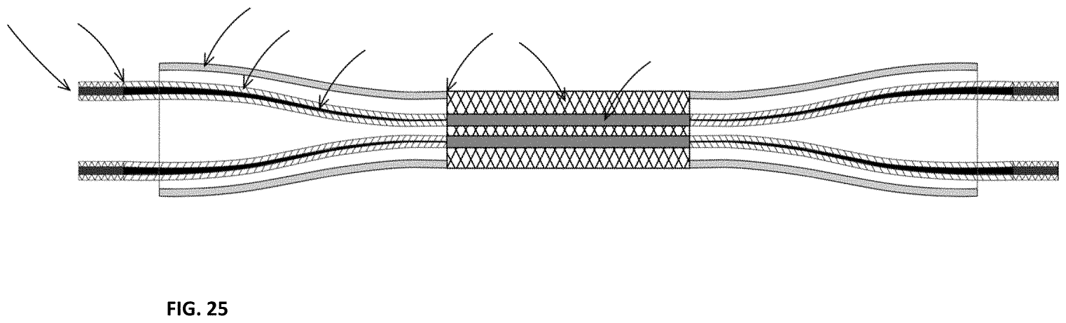

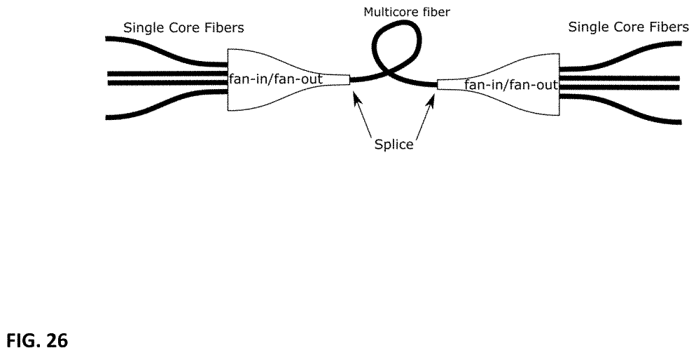

Once the capillary template is provided the fan-in/fan-out is produced as follows. A single-core fiber is inserted into each access hole of the template. Note that the access holes may extend all of the way through the template or not, since ultimately the template will be tapered down along a portion containing the single-core fibers. Note also that the index profile of the single-core fibers is not limited to step index profiles. For example, graded index, trapezoidal, logarithmic or other index-profile single-core fibers may be used so that upon tapering loss and/or crosstalk of the final fan-in/fan-out device can be controlled. Moreover, a graded index fiber or other index-profile single-core fiber may be spliced to the output single-core fiber and inserted into the access hole (FIG. 25).

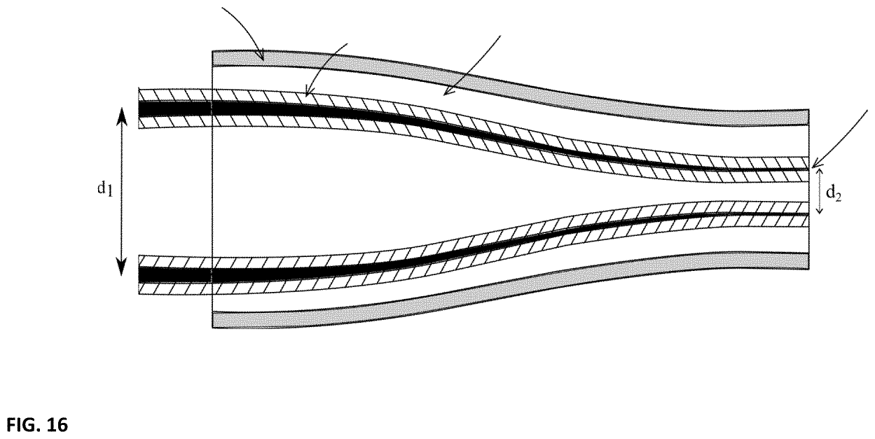

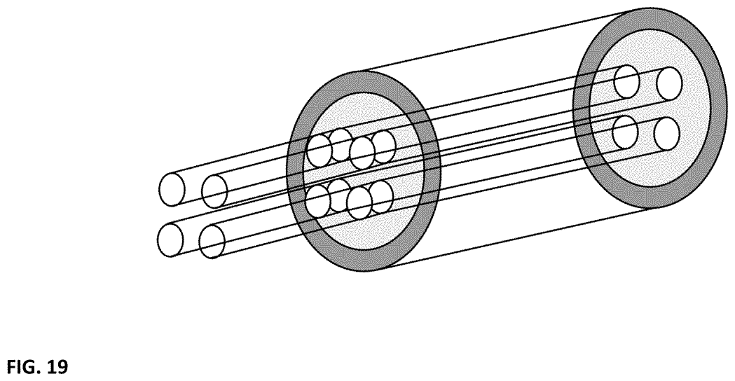

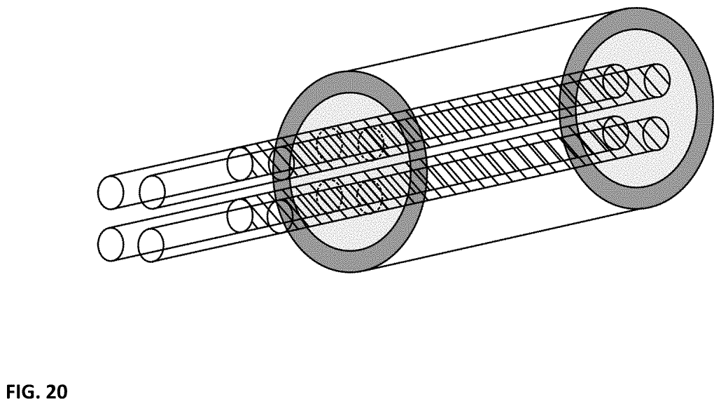

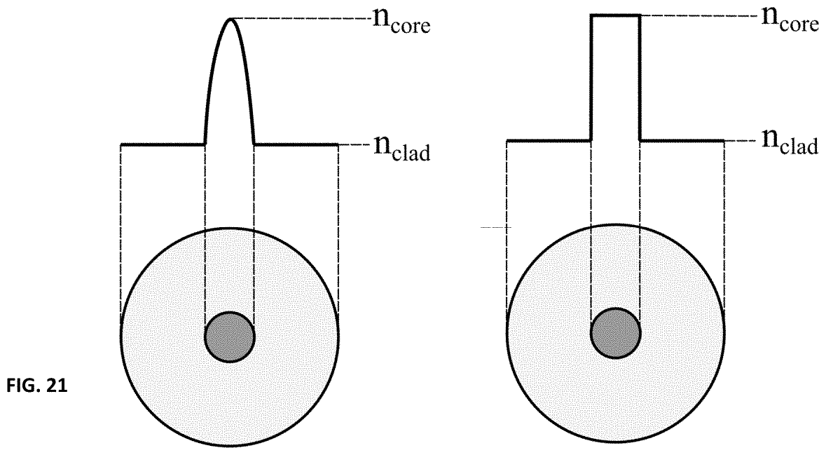

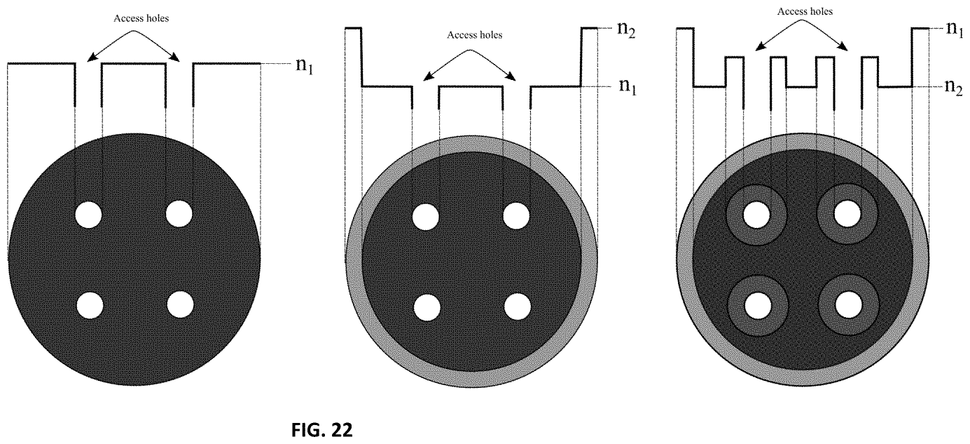

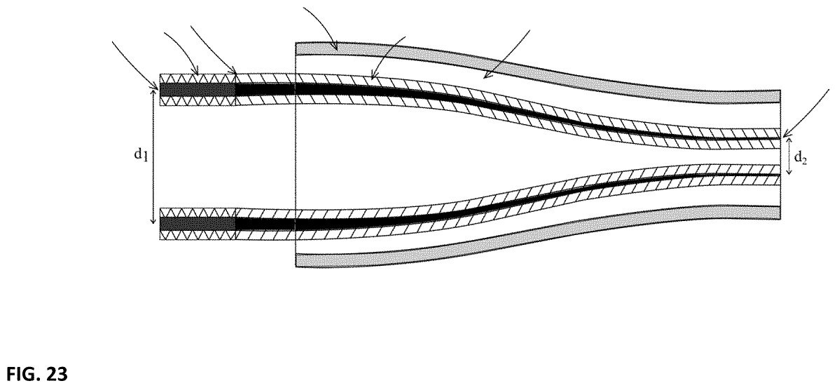

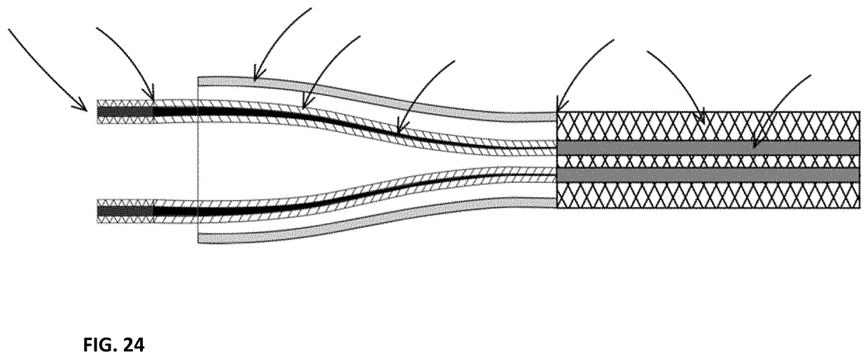

After inserting the single-core fibers into the capillary template, the diameter of the capillary/fiber assemble is further reduced (tapered down) so as to match the core-to-core distance/spacing/orientation of the selected multicore fiber as illustrated in FIGS. 17, 18 and 27. This is done by heating and elongating the capillary template/fiber assembly. During the tapering process the single-core fibers and the glass capillary template fuse together (FIG. 16). The tapered multicore fiber end (small diameter end) of the fan-in/fan-out device becomes the multicore fiber interface (see, e.g., FIGS. 16-18, 27), which can then be directly spliced to a multicore fiber (FIGS. 16, 19). The length of the tapered region is advantageously between 0.5 to 15 cm, more advantageously from 1 to 7 cm. The ratio between the maximum outer diameter and minimum outer diameter (tapering ratio) of the fan-in/fan-out device can fall between 2 to 30, preferably between 5 to 15. The tapering ratio is chosen to match core-to-core distance of the multicore fiber. The smaller diameter region of the fan-in/fan-out device is then cleaved. At this cleaved end the fan-in/fan-out device resembles a multicore fiber. Here, the individual single core fibers became the cores of the multicore fiber while the low refractive index capillary template becomes the cladding of the multicore fiber. The multicore fiber end of the device can then be spliced to a multicore fiber. Alternatively, the fan-in/fan-out can be mechanically coupled to the multicore fiber.

The fan-in/fan-out device depicted in FIGS. 16-17 shows the single core fibers inserted into the capillary template and the tapered section. By using a controlled tapering process the core-to-core distance of the fan-in/fan-out device at the small diameter end matches the core-to-core distance of the multicore fiber within ±5 μm, advantageously within ±2 μm. This allows for a low loss connection between the fan-in/fan-out and the multicore fiber at the splice point. In order to increase the coupling efficiency from the single-core fiber into the multicore fiber one has to closely match the mode field diameters at the multicore fiber end of the fan-in/fan-out and the multicore fiber. The capillary template is designed to allow for a mode transition from each individual fiber at the single-core fiber end of the fan-in/fan-out to the tapered waist in an adiabatic, low-loss manner. During the taper transition, the light in each individual single-core fiber cannot be contained within its core because the core diameter is reduced. However, the lower refractive index of the capillary template, the light is confined by the capillary template, avoiding light leakage into the neighboring channels, reducing crosstalk and loss at the same time.

We found it advantageous to design the outer diameter of the capillary template so that the diameter of the multicore fiber end of the fan-in/fan-out device matches that of the multicore fiber within ±15% (i.e., within ±18 μm for a 125 μm outer diameter fiber). We found that this is helpful to further reduce the splice losses between the fan-in/fan-out and the multicore fiber as it allows for a better alignment during the splice compared to splicing fibers with different cladding diameters. However, this may not be fundamental to the performance of the device.

We also note that different types of single core fibers could be inserted into the capillary template, which would impact the device performance. For some applications the single-core fibers of the fan-in/fan-out device may need to be spliced to external conventional single mode fibers, for example to ITU G. 652 fibers. Therefore, one advantageously will use single core fibers that could be spliced with low loss to external single mode fibers. In our experimental demonstrations the fibers that we insert into the holes of the capillary are short sections of graded index fibers 1 cm to 10 cm long. These short sections of graded index fibers are spliced to commercial single mode fibers on the other end with losses below 0.2 dB. The short lengths of graded index fiber that are inserted into the capillary template allow us to taper the fan-in/fan-out device in a more adiabatic fashion compared to using step index fibers. In other words, as the capillary template/fiber assembly is tapered down, the graded index single core fibers maintain a slow rate of change of the mode field profile. The use of graded index fibers is beneficial in two ways: firstly, the length of the tapered section of the fan-in/fan-out device can be tailored without additional loss/crosstalk penalties; and secondly, the device is more robust to fabrication imperfections, which contributes to repeatably and consistently fabricating low loss fan-in/fan-out devices.

Modeling and Results

### EXAMPLES

In order to increase the coupling efficiency between external single core fibers and a multicore fiber through the fan-in/fan/out device, matching the mode field diameters at both ends of the device is important. In the exemplary device presented, the single core fibers used for the fan-in/fan-out device fabrication are designed to minimize loss at the specific wavelength of 1550 nm. The external single core fiber is spliced with low loss to a single core fiber which is then inserted into the capillary template. This single core fiber is elongated using a capillary template. Along the elongated region of the fan-in/fan-out, a mode transition occurs that allows to obtain a mode field diameter similar to that of the external multicore fiber at the end multicore fiber end of the fan-in/fan-out. This allows to reduce splice losses at both the multicore fiber end and the external single core fiber end of the fan-in/fan-out. Table 1 shows the calculated values of the mode field diameter of each of the fibers that are used in the fan-in/fan-out fabrication and also the multicore fiber. The single core fibers used for the fan-in/fan-out fabrication consist but are not limited to a graded index fiber with a core radius of 9 μm and core refractive index difference Δ of 16×10⁻³. The single core fiber is chosen to be of approximately a parabolic index profile to help with the adiabaticity along the elongated section of the fan-in/fan-out device. However, single core fibers with other index profiles such a step index fibers, trapezoidal index fibers, logarithmic index profiles, to name a few could be used if matching of the mode field diameters at both ends of the fan-in/fan-out device can be obtained in order to achieve low loss.

TABLE 1

| | Mode Field Diameter |
|---|---|
| | (Calculated value) (μm) |
| Single core external fiber | 10.37 × 10⁻³ |
| Single core fiber fan-in/fan-out | 9.97 × 10⁻³ |
| Individual core at multicore fiber end of | 10.06 × 10⁻³ |
| the fan-in/fan-out device | |
| Multicore fiber | 10.44 × 10⁻³ |

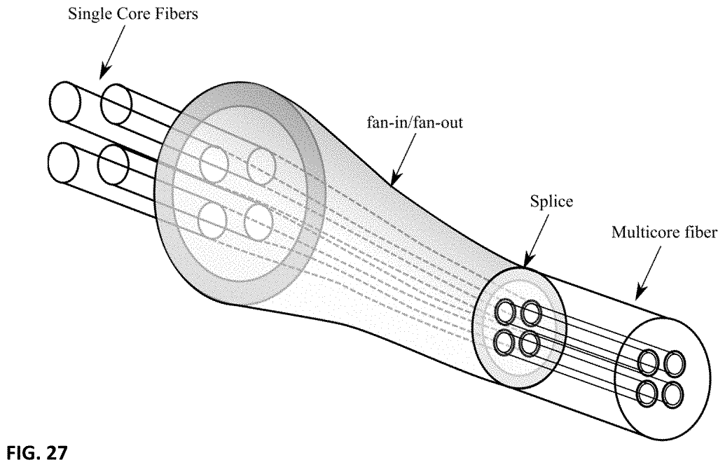

In this example, the number of cores of the multicore fiber is 4. Table 2 shows the calculated values of the splice loss between the external single core fiber and the single core fiber used for the fan-in/fan-out device fabrication. Also shown is the calculated splice loss between the multicore fiber end of the fan-in/fan-out device and the external multicore fiber. The total calculated splice loss of the device (from external single mode fiber to external multicore fiber) is 0.011 dB. Here two fan-in/fan-out devices are fabricated and spliced to a short section of multicore fiber for characterization insertion loss and crosstalk (FIGS. 26, 27). Table 3 shows the measured insertion loss and crosstalk over a short multicore fiber to external single core fibers on both ends by two fan-in/fan-out devices. The insertion loss values are below 0.5 dB link and the crosstalk is well below −60 dB across all the cores. Further optimization of the fabrication and splicing process can help to further reduce the insertion loss

TABLE 2

| | Splice loss |
|---|---|
| | (Calculated value) (dB) |
| Splice between single mode fiber and single | 0.064 |
| core fiber | |
| Splice between tapered end of the fan-in/fan- | 0.041 |
| out and multicore fiber | |
| Total splice loss | 0.105 |

TABLE 3
Insertion loss and crosstalk of multicore fiber link with fan-in/
fan-out on both ends (dB)

| | 1 | 2 | 3 | 4 |
|---|---|---|---|---|
| 1 | −0.48 | −66.5 | −62.3 | −64.5 |
| 2 | −65.4 | −0.46 | −66.7 | −64.3 |
| 3 | −68.3 | −62.2 | −0.41 | −67.6 |
| 4 | −68.5 | −64.1 | −63.4 | −0.49 |

Notwithstanding that the numerical ranges and parameters setting forth the broad scope of the disclosed embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While various disclosed embodiments have been described above, it should be understood that they have been presented by way of example only and not as a limitation. Numerous changes to the disclosed embodiments can be made in accordance with the specification herein without departing from the spirit or scope of this specification. Thus the breadth and scope of this specification should not be limited by any of the above-described embodiments; rather, the scope of this specification should be defined in accordance with the appended claims and their equivalents.

We claim:

1. A capillary template for a fan-in/fan-out device, comprising:
an elongate, solid cylindrical body having a plurality of longitudinal access holes, wherein the solid cylindrical body has at least one region surrounding each access hole having a refractive index that is lower than the cladding refractive index of the single-core fibers used in fabricating the fan-in/fan-out.

2. The capillary template of claim 1, wherein the plurality of longitudinal access holes are through-holes.

3. The capillary template of claim 1, wherein all of the surrounding region has a uniform index distribution.

4. The capillary template of claim 1, wherein the at least one region surrounding each access hole is Fluorine-doped silica.

5. The capillary template of claim 1, further comprising a single-core fiber disposed in each access hole.

6. The capillary template of claim 5, further comprising a different fiber spliced to an end of each single-core fiber and disposed within the respective longitudinal access holes.

7. The capillary template of claim 6, wherein each different fiber is a graded index fiber or any other single core fiber.

8. The capillary template of claim 5, wherein the plurality of single-core fibers extend out of the respective access holes.

9. A fan-in/fan-out device, comprising:
an elongate, tapered capillary body having a single-core fiber end and a multicore fiber end, and a tapered section intermediate therein, wherein a diameter of the capillary body is reduced from the single-core fiber end towards the multicore fiber end;
a plurality of single-core fibers disposed in the capillary body;
a respective plurality of light-propagating regions extending from the single-core fiber end to the multicore fiber end of the capillary body,
wherein the single-core fibers have a cladding having a lower index of refraction than the light-propagating regions and the capillary body has one or more transverse regions having index values that are less than the single-core fiber cladding indices,
further wherein as the capillary body tapers from the single-core fiber end towards the multicore-fiber end, the light confinement function of the lower index fiber cladding being increasingly provided by the lower index region(s) of the capillary surrounding region(s).

10. The fan-in/fan-out device of claim 9, wherein at least one of the plurality of single-core and/or the multicore fiber end include a connector(s).

11. The fan-in/fan-out devices of claim 9, connected to each end of a multicore fiber.

12. A method for making a capillary template for a fan-in/fan-out device, comprising:
providing at least a first hollow tube having outside diameter, D1, and index, n1, and at least a first solid rod having an outside diameter, DR, and index, nR;
drawing the at least first hollow tube and the at least first solid rod into lengths having smaller diameters than D1, while not completely collapsing the inner air space of the hollow tube(s);
assembling a plurality of the drawn tubes and the drawn rods in a desired configuration to create a preform stack; and
drawing down the preform stack to create a capillary template having a plurality of precisely aligned/positioned air channels, wherein the air channels' diameters are sized to allow the insertion of single-core fibers,
wherein at least one region surrounding the air channels has a refractive index less than the cladding refractive index of the inserted single-core fibers.

13. The method of claim 11, further wherein the at least first hollow tube has a plurality of concentric regions of different refractive indices, n1, n2, . . . nᵢₙₙₑᵣₘₒₛₜ, where nᵢₙₙₑᵣₘₒₛₜ is the region surrounding the air channels.

14. The method of claim 11, further comprising:
providing at least a second hollow tube having outside diameter, D2, and index, n2, where nR is smaller or equal to n2;
drawing down the at least first and second hollow tubes and the at least first solid rod such that the first tube can be concentrically disposed in the second tube; and
assembling and drawing down the stacked preform.

15. A method for making a fan-in/fan-out device, comprising:
providing a capillary template;
inserting a single-core fiber into each respective access hole;
elongating and tapering down the capillary template including the fibers disposed therein,
whereby the single-core end and the multicore fiber end can be connected to a respective single-core fiber end and a multicore fiber end of a transmission system.
